(19) United States
(12) Patent Application Publication
(10) Pub. No.: US 2002/0186129 A1
(43) Pub. Date: Dec. 12, 2002

(54) Noise level indicator for providing feedback of noise level to persons and method for controlling noise

(76) Inventor: Fran Rebello, Chico, CA (US)

Correspondence Address: PARENT PATENT RESEARCH, INC, 600 NORTH PICKETT STREET, ALEXANDRIA, VA, 22304

(21) Appl. No.: 09/876,024

(22) Filed: Jun. 8, 2001

(51) Int. Cl. G08B 21/00

(52) U.S. Cl. 340/540; 340/565

(57) ABSTRACT

A noise level indicator in the form of a traffic light having respective red, yellow, and green lights. The noise level indicator receives ambient noise through a built-in microphone and compares the ambient noise level against a predetermined acceptable decibel level. The noise level indicator shows whether the ambient noise level is below, at, or above the predetermined acceptable decibel level by respectively illuminating the green, yellow, or red light. The red light can be accompanied by an audible siren, and the yellow light flashes to call attention to borderline and unacceptable ambient noise levels.

### BACKGROUND OF THE INVENTION

1. Field of Invention

The present invention relates to sound and noise level indicators, and more specifically to noise level indicators which visually indicate the noise level using lights.

2. Description of Related Art

### Monitoring of Noise levels

The monitoring of noise levels is of prime importance such as for speakers in auditoriums so everyone present can comfortably hear the speaker, and at rock concerts so the band can be heard at a satisfactorily loud volume level which does not damage the hearing of those in attendance. Likewise. undesirable sounds, or ambient noise, is desirable to be monitored in classrooms, and back stage at theater so as not to reach a level which is disturbing to others.

### Noise level Indicators

A noise level monitoring and indicating system is disclosed in U.S. Pat. No. 4,424,511 issued to Alberts, Jr. The system designed for use in classrooms, buses, and other such relatively large areas in which the noise level is to be monitored. A plurality of individual microphones are distributed about in the area to be monitored. The microphones are each connected to a box having a plurality of voice operated relays, one for each microphone. When a voice operated relay sends a noise level above its operating threshold, it increments a counter and activates a relay which controls an external reinforcement device comprising a green, a yellow, and a red light signifying that the predetermined maximum noise level has been exceeded. The audio signal detected by each voice activated relay is coupled to an additional voice operated relay which includes a connector and a relay output device similar to those in the individual channels. This additional voice operated relay functions as a summing device for ambient noise levels sensed throughout the area monitored by all of the microphones. Each voice operated relay also provides an output via a sensor selector switch and audio amplifier to a decibel meter, a monitor speaker, and optional remote monitors.

A noise level indicator specifically designed for use in a classroom is disclosed in U.S. Pat. No. 3,480,912 issued to Speeth et al. The device includes a plurality of lights which are sequentially illuminated in accordance with the noise level detected by an attached microphone. The system is used to provide feedback to students as to whether they are speaking too softly, at the right sound level, or too loudly.

Gibbs in U.S. Pat. No. 3,440,349 and Gibbs et al. in U.S. Pat. No. 3,797,012 provide ambient noise level indicator systems wherein a microphone detects the ambient noise level and an electronic noise circuit controls a plurality of lamps in response to the volume of ambient noise detected by the microphone whereby an indication of an acceptable ambient noise level or unacceptable ambient noise level is provided.

Ford et al. in U.S. Pat. No. 3,304,368 is another example of prior art systems where a means is provided to indicate when the ambient noise level within a school bus exceeds a predetermined value and Ott in U.S. Pat. No. 3,582,671 provides a visual indication when the ambient noise level in a study room or library exceeds a predetermined level.

Many systems have been developed to determine ambient noise levels and to provide a qualitative indication of the instantaneous ambient noise levels. However, there is a need for an attractive device which catches the eye of persons present, which has an adjustable sensitivity level to indicate the particular decibel level of the noise desired by the individual user, which provides feedback in a fun and interesting way so people use it, which provides auxiliary attention-getting features besides visual indicators, and which has the flexibility to be placed on a table or hung on a wall to maximize visibility.

### SUMMARY OF INVENTION

### 1. Advantages of the Invention

One of the advantages of the present invention is that it provides an attractive, attention-getting design for a noise level indicator.

A further advantage of the present invention is that it provides feedback in a fun and interesting way so people use it

Another advantage of the present invention is it provides auxiliary attention-getting features including flashing light and sound.

Another advantage of the present invention is it provides an adjustable sensitivity level to indicate the particular decibel level of the noise desired by the individual user as indicated by the lights and sounds.

Another advantage of the present invention is the flexibility to be placed on a table or hung on a wall to maximize visibility.

These and other advantages of the present invention may be realized by reference to the remaining portions of the specification, claims, and abstract.

### 2. Brief Description of the Invention

The invention comprises a noise level indicator and a method of use of the noise level indicator to provide indication to persons present in the adjacent area of the ambient noise level,

The noise level indicator includes a microphone adapted to pick up and convert ambient sound waves to an electrical signal. An audio amplifier is operatively connected to the microphone for receiving and amplifying the electrical signal. A logic network is operatively connected to said audio amplifier for receiving an output from the audio amplifier. The logic network is adapted to produce electrical output signals indicative of the ambient noise level input to the microphone. An indicator is operatively connected to the logic network which is adapted to convert the electrical output signals from the logic network to indications of the ambient noise level. The indications include when the ambient noise level is generally below a predetermined decibel level, is generally at the predetermined decibel level, and is generally above the predetermined decibel level. The indications are perceptible by the persons in the adjacent area to provide feedback to them when ambient noise levels are getting too high or actually too high.

The noise level indicator is preferably includes an elongate, generally rectangular housing configured to generally resemble a traffic signal. The housing has a front side with three large holes disposed in a vertical line one above the other. The housing encloses the audio amplifier, the logic network, the indicator, and preferably the microphone. The indicator comprises three lights of different colors which are visible through respective of the three large holes. An uppermost light appears red when illuminated, a middle light appears yellow when illuminated, and a lowermost light appears green when illuminated. The logic network is adapted to cause the lowermost light to illuminate when the ambient noise level is generally below the predetermined decibel level, cause the middle light to illuminate when the ambient noise level is generally at the predetermined decibel level, and cause said uppermost light to illuminate when the ambient noise level is generally above the predetermined decibel level. A variable sensitivity selector is operatively connected the audio amplifier and the logic network to allow manual control of the output from the audio amplifier to the logic network so as to effectively control the predetermined decibel level at which the respective lights illuminate.

The method of using the noise level indicator is for controlling the ambient noise level of persons present in a specified area. The method comprises two steps, the first of which is providing a noise level indicator in the form of a traffic light having respective red, yellow, and green illuminating lights responsive to the ambient noise level in the specified area. The second step comprises providing feedback concerning the ambient noise level to the persons present in the specified area using the noise level indicator by providing indications that the ambient noise level is acceptable by illuminating the green light, is marginal by illuminating the yellow light, and is excessive by illuminating the red light.

The method preferably includes the yellow light illuminating by flashing, and the red light being accompanied by a siren to farther attract attention when ambient noise levels are getting too high or are too high.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

Preferred embodiments of the present invention are shown in the accompanying drawings wherein:

FIG. 1 is substantially a front quarter perspective view of a noise level indicator according to the invention;

FIG. 2 is substantially an exploded view of the noise level indicator;

FIG. 3 is substantially a schematic circuit diagram showing the circuit features of the noise level indicator; and

FIG. 4 is substantially a schematic block diagram of the system of FIG. 3.

### DESCRIPTION OF THE PREFERRED EMBODIMENT

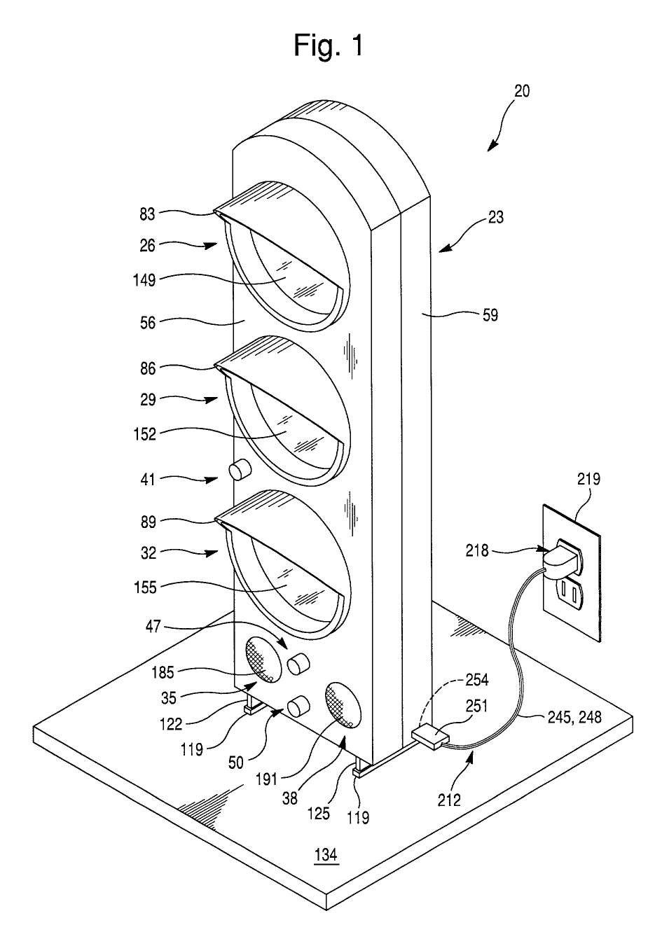

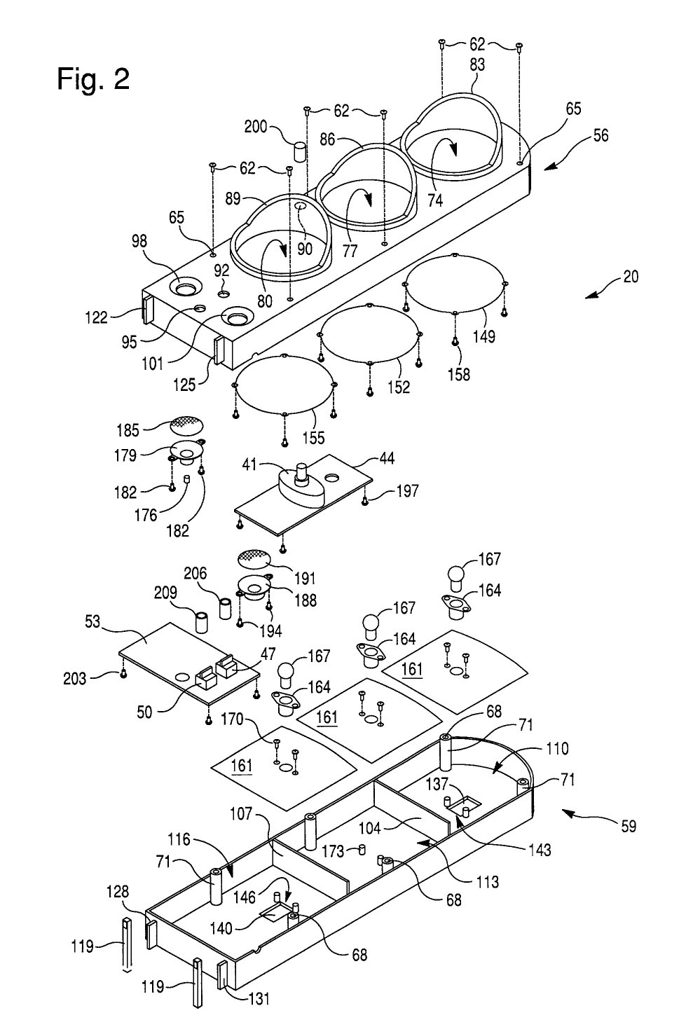

As shown in FIGS. 1 and 2, the present invention is a noise level indicator, generally indicated at 20. Noise level indicator 20 comprises a housing 23, respective red, yellow, and green light assemblies 26, 29, and 32, a microphone assembly 35, a speaker assembly 38, a rotary sensitivity selector switch 41 attached to a first circuit board 44, and respective main power and sound on/off switches 47 and 50 attached to a second circuit board 53.

### Housing

The housing 23 is in the form of a stoplight as used to control the flow of motor vehicle traffic on streets. Housing 23 includes a front half shell 56 and a mating rear half shell 59 which connect together using a plurality of screws 62 which extend through respective holes 65 in front half shell 59 and threadably engage respective threaded holes 68 of respective mounting posts 71 of rear half shell 59. Front half shell 56 includes respective light holes 74, 77, and 80, covered from above by respective sun shades 83, 86, and 89. A selector switch hole 90, a pair of switch holes 92 and 95, a microphone hole 98, and a speaker hole 101 extend through front half shell 56 below light opening 80. Rear half shell 59 includes a pair of separation baffles 104 and 107 which split housing 23 into three separate light chambers 110, 113, and 116. Housing 23 includes a pair of cushion legs 119 which mount to respective tabs 122 and 125 of front half shell 56 and tabs 128 and 131 of rear half shell 59 for placement of noise level indicator 20 on a horizontal surface 134. Alternatively, rear half shell 59 includes a pair of mounting key holes 137 and 140 in respective rearward projections 143 and 146 for wall mounting noise level indicator 20.

### Light Assemblies

Red, yellow, and green light assemblies 26, 29, and 32 include respective translucent red, yellow, and green filters 149, 152, and 155 which connect to front half shell 56 covering the respective light holes 74, 77, and 80 using a plurality of screws 158 which thread into mating threaded holes (not shown) in front half shell 56. Light assemblies 26, 29, and 32 each further include a reflector 161, a light bulb socket 164, and a light bulb 167. Reflectors 161 and sockets 164 attach to rear half shell 59 within the respective light chambers 110, 113, and 116 using a plurality of screws 170 which extend through reflectors 161 and sockets 164 into pairs of threaded posts 173. Light bulbs 167 extend through the respective reflectors 161, twist locking into the respective sockets 170. The respective light bulbs 167 are arranged to illuminate the respective chamber 110, 113, and 116 shining through the respective red, yellow, and green filter 149, 152, and 155.

### Microphone Assembly

The microphone assembly 35 includes a microphone 176 which fits into a funneled mounting bracket 179. Microphone 176 provides an input signal to audio amplifier circuit 227. Mounting bracket 179 connects to front half shell 56 directly behind microphone hole 98 using a plurality of screws 182 which extend through mounting bracket 179 and threadably engage front half shell 56. A decorative screen 185 is disposed between mounting bracket 179 and front half shell 56.

### Speaker Assembly

Speaker assembly 38 includes a speaker 188 which connects to front half shell 56 directly behind speaker hole 101 with a decorative screen 191 therebetween using a plurality of screws 194 which extend through speaker 188 and threadably engage front half shell 56.

### Rotary Selector Switch, Circuit Boards, On/Off Switches, and Power

Circuit board 44 with attached rotary switch 41 attach to front half shell 56 using a plurality of screws 197, being positioned such that a rotary knob 200 of rotary selector switch 41 extends through selector switch hole 90 of front half shell 56 for operation external of housing 23.

Circuit board 53 with attached on/off switches 47 and 50 attach to front half shell 56 using a plurality of screws 203, being positioned such that respective push buttons 206 and 209 of on/off switches 47 and 50 extend through the respective switch holes 92 and 95 of front half shell 56 for operation external of housing 23.

The noise level indicator 20 is provided with a suitable power cord 212 so that it can be connected to a convenient A.C. outlet (not shown).

### Circuitry

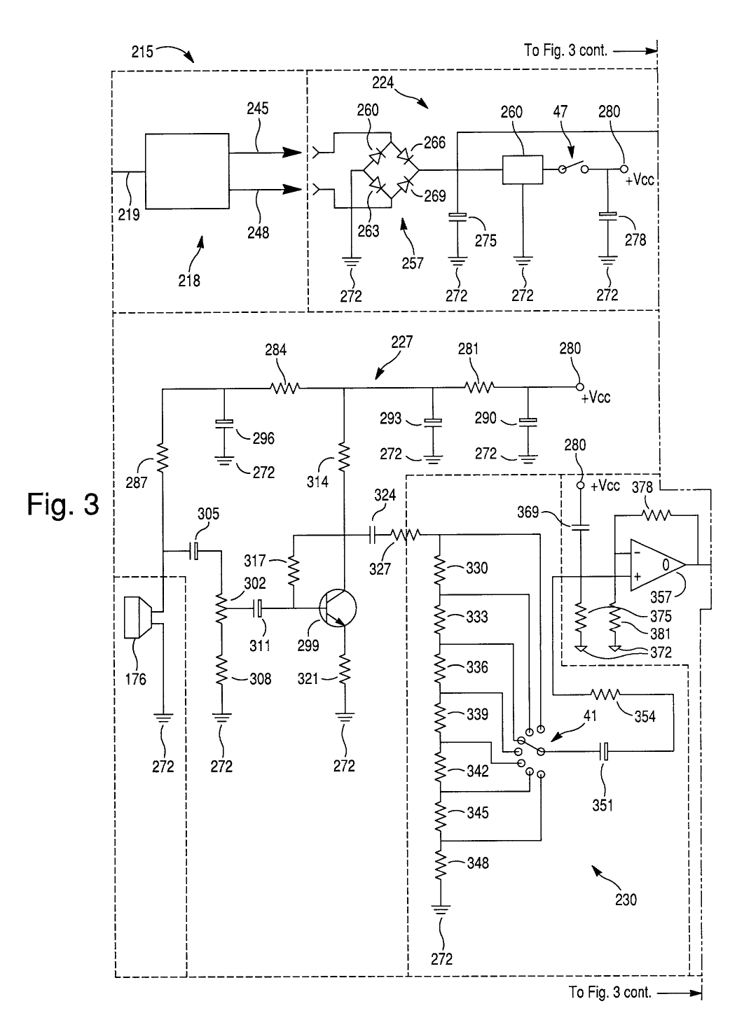

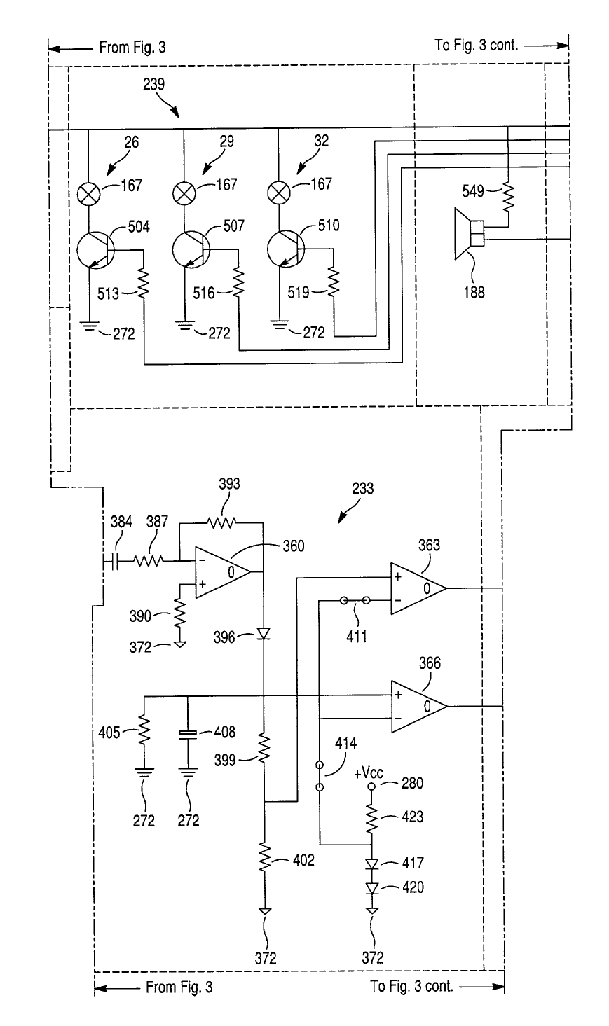

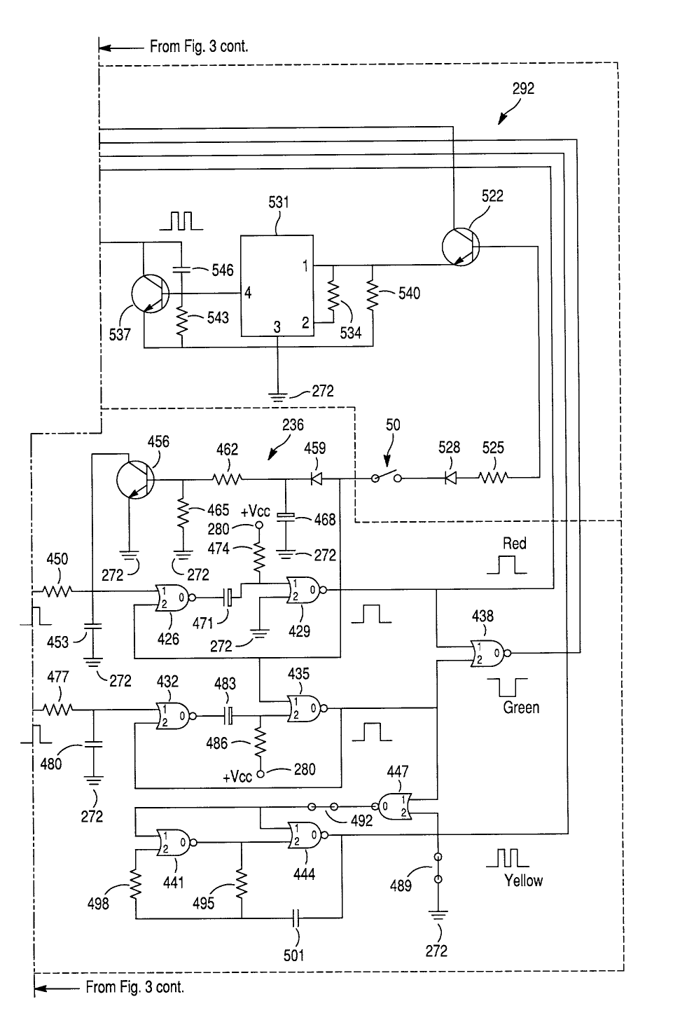

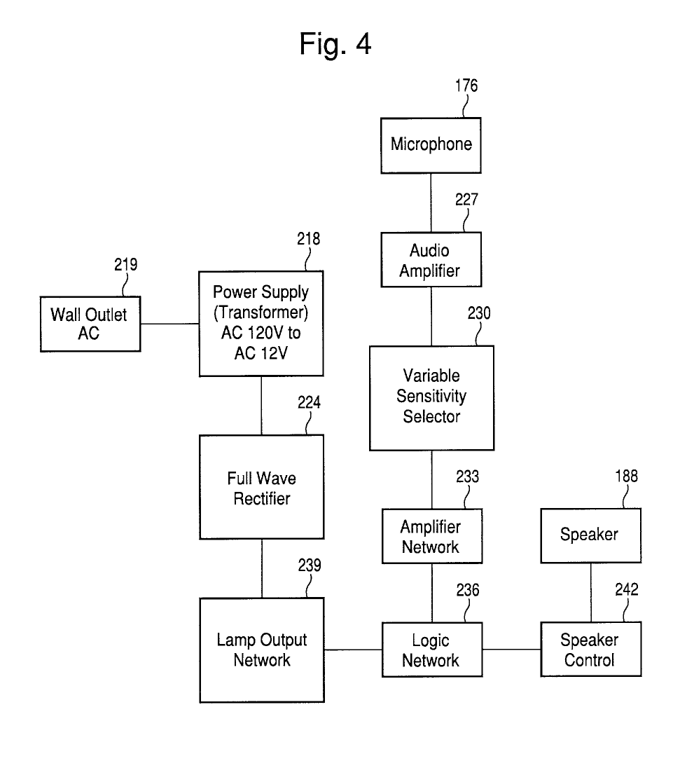

Noise level indicator 20 includes circuitry as is generally indicated at 215 in FIGS. 3 and 4. Circuitry 215 includes a power supply 218 which connects to an alternating current (AC) 120 volt, 60 cycle electrical power source 221 such as a wall outlet. A full wave rectifier circuit 224 rectifies the AC electrical power into direct current (DC) which powers the other circuits. Microphone 176 provides an input signal to an audio amplifier circuit 227, which signal is amplified as an output signal which is fed to a variable sensitivity selector circuit 230. The output signal of variable sensitivity selector circuit 230 is fed to an amplifier network 233 and the output signals thereof are sent to a logic network 236. The output signals of logic network 236 are sent to both of a lamp output network 239 and a speaker control circuit 242. The output signal of lamp output network 242 is in the visual form of red, yellow, and green light assemblies 26, 29, and 32 respectively being illuminated. The output signal of speaker control circuit 242 is fed to speaker 188 for providing an audio sound signal to persons.

Power Supply Circuit: Power supply 218 can a separate device which plugs into noise level indicator 20 as shown, or can be built into housing 23 as an integral part of noise level indicator 20. Power supply 218 as shown is of the off-the-shelf type which includes a pair of prongs (not shown) which connect to a wall socket 219 which supplies 120 volt, 60 cycle electrical power. A transformer (not shown) within power supply 218 converts the 120 volts to 12 volts, 60 cycle at a lower amperage. A pair of output wires 245 and 248 are connected from the transformer to an end plug 251 which removably connects to a mating socket 254 affixed within housing 23.

Rectifier Circuit: Full wave rectifier circuit 224 includes a full wave rectifier bridge 257, having a plurality of diodes 260, 263, 266, and 269, rectifies the 12 volt, 60 cycle electrical power received at socket 254, supplying positive voltage to an integrated circuit 260, and being connected to ground 272. A pair of capacitors 275 and 278 each connect to ground 272. The positive voltage is applied through the main power on/off switch 47 to a positive voltage feed 280 which powers the other circuits, which are connected to ground 272.

Audio Amplifier Circuit: Audio amplifier circuit 227 receives input from microphone 176 which is connected to the positive voltage feed 280 through a series of resistors 281, 284, and 287, and which is also connected to ground 272. Respective capacitors 290, 293, and 296 connect to the positive voltage ground 272 between resistors 281, 284, and 287. A transistor 299 is used to amplify the signal from microphone 176, the base thereof receiving input through a variable resistor 302 connected to microphone 176 through a capacitor 305 and through a resistor 308 to ground 272 and through a capacitor 311,and resistor 281 and a pair of resistors 314 and 317. The emitter of transistor 299 is connected through a resistor 321 to ground 272 and the collector thereof is connected to resistors 314 and 317, and through a capacitor 324 and resistor 327 to the variable sensitivity selector circuit 230.

Variable Sensitivity Selector Circuit: Variable sensitivity selector circuit 230 includes a plurality of resistors 330, 333, 336, 339, 342, 345, and 348 which are connected in series between resistor 327 of audio amplifier circuit 227 and ground 272. Connections are made between the respective resistors 330, 333, 336, 339, 342, 345, and 348 to rotary selector switch 41, which is a seven step rotary type switch. The output of rotary selector switch 41 connects to amplifier network 233 through a capacitor 351 and resistor 354. Therefore, a variable resistance can be applied between transistor 299 and amplifier network 233 to vary the sensitivity to ambient noise input to microphone 176.

Amplifier Network: Amplifier network 233 comprises a plurality of amplifiers 357, 360, 363, and 366. The output from rotary selector switch 41 connects to the positive (+) input of amplifier 357 through capacitor 351 and resistor 354, along with the positive voltage feed 280 through a capacitor 369, and a secondary ground 372 through a resistor 375. The negative input (−) of amplifier 357 is connected to the output (o) thereof through a resistor 378. The negative (−) input of amplifier 357 is also connected to secondary ground 372 through a resistor 381. The negative (−) input of amplifier 360 is connected to the output (o) of amplifier 357 through a capacitor 384 and a resistor 387. The positive (+) input of amplifier 360 is connected to secondary ground 372 through a resistor 390. The negative input (−) of amplifier 360 is connected to the output (o) thereof through a resistor 393. The output (o) of amplifier 360 is connected through a diode 396, a resistor 399, and a resistor 402 to secondary ground 372, and through diode 396 through parallel resistor 405 and diode 408 to ground 272. The output (o) of amplifier 360 is also connected through diode 396 and resistor 399 to the positive (+) input of amplifier 363. The negative (−) input of amplifier 363 is connected through a switch 411 both to the negative (−) input of amplifier 366, and through a switch 414 and diodes 417 and 420 to secondary ground 372. Positive voltage feed 280 is also connected through diodes 417 and 420 to secondary ground 372, but through a resistor 423. The output (o) of each of amplifiers 363 and 366 are input to logic network 236 as square wave pulses.

Logic Network: Logic network 236 comprises a plurality of OR gates 426, 429, 432, 435, 438, 441, 444, and 447 which control the illuminating of the respective red, yellow, and green light assemblies 26, 29, and 32. The output (o) of amplifier 363 is connected to a first input (1) of OR gate 426 through a resistor 450, and to ground 272 through a capacitor 453. The collector of a transistor 456 is also connected to the first input (1) of OR gate 426. The emitter of transistor 456 is connected to ground 272 and the base thereof is connected to speaker control circuit 242 through a diode 459 and a resistor 462, and connected to ground through a resistor 465 and a capacitor 468. The output (o) of OR gate 426 is connected through a capacitor 471 both to an input (1) of OR gate 429 and through a resistor 474 to positive voltage feed 280. A second input (2) of OR gate 426 is connected to an output (o) of OR gate 429, which connects respectively to diode 459, to lamp output network 239, and to a first input (1) of OR gate 438. The output (o) of amplifier 366 is connected to a first input (1) of OR gate 432 through a resistor 477, and to ground 272 through a capacitor 480. The output (o) of OR gate 432 is connected through a capacitor 483 both to an input (1) of OR gate 435 and through a resistor 486 to positive voltage feed 280. A second input (2) of OR gate 432 is connected to an output (o) of OR gate 435, which connects both to a second input (2) of OR gate 438 and to a first input (1) of OR gate 447. A second input (2) of OR gate 447 connects to ground 272 through a switch 489. An output (o) of OR gate 447 connects through a switch 492 to respective first inputs (1) of OR gates 441 and 444. An output (o) of OR gate 441 connects to a second input (2) of OR gate 444, and through a pair of resistors 495 and 498 to a second input (2) of OR gate 441. An output (o) of OR gate 444 connects to lamp output network 239, and through a capacitor 501 to intermediate resistors 495 and 498 so as to connect through the respective resistors 495 and 498 to the respective second inputs (2) of OR gates 444 and 441.

Lamp Output Network: Lamp output network 239 comprises a plurality of transistors 504, 507, and 510, the respective bases of which are respectively connected to the output (o) of OR gate 429, the output (o) of OR gate 444, and the output (o) of OR gate 438, through respective resistors 513, 516, and 519. The emitters of each transistor 504, 507, and 510 is connected to ground 272, and the collectors thereof are respectively connected to the red, yellow, and green light assemblies 26, 29, and 32 for respective illumination of the light bulb 167. Each of light bulbs 167 is also connected to the positive voltage output of rectifier bridge 257.

Speaker Control Circuit: The speaker control circuit 242 includes a first transistor 522, the base of which is connected to diode 459 of logic network 236 connecting through resistor 462 to the base of transistor 456 thereto. A resistor 525, a diode 528, and sound on/off switch 50 are disposed between diode 459 and transistor 522, switch 50 allowing the electrical power to speaker control circuit 242 to be cut to allow operation of noise level indicator 20 in a visual mode only if desired. The collector of transistor 522 is connected to the positive voltage output of rectifier bridge 257. The emitter of transistor 522 is connected directly to a first connection (1) of an integrated circuit 531, and through a resistor 534 to a second connection (2) of integrated circuit 531. The emitter of transistor 522 is connected to an emitter of a second transistor 537 through a resistor 540, and to a first connection (1) of speaker 188 through resistor 540, a resistor 543, and a capacitor 546. Integrated circuit 531 at a third connection (3), and the emitter of transistor 522 through resistor 540 are connected to ground 272. A fourth connection (4) of integrated circuit 531 connects to the base of second transistor 537 and to the connection from the collector of transistor 522 to microphone 188 intermediate resistor 543 and capacitor 546. The collector of transistor 537 connects to the first connection (1) of speaker 188. A second connection (2) of speaker 188 connects through a resistor 549 to the positive voltage output of rectifier bridge 257. Speaker 188 provides an audio sound signal to persons in addition to the visual signal sent through the red, yellow, and green light assemblies 26, 29, and 32.

### CONCLUSION

It can now be seen that the present invention solves many of the problems associated with the prior art. The present invention provides an attractive, attention-getting design for a noise level indicator. The present invention provides feedback in a fin and interesting way so people use it. The present invention provides auxiliary attention-getting features including flashing light and sound. The present invention provides an adjustable sensitivity level to indicate the particular decibel level of the noise desired by the individual user as indicated by the lights and sounds. The present invention provides the flexibility to be placed on a table or hung on a wall to maximize visibility.

Although the description above contains many specifications, these should not be construed as limiting the scope of the invention but as merely providing illustrations of some of presently preferred embodiments of this invention. The specification, for instance, makes reference to specific circuit designs. However, obviously there are many ways to design electrical circuits to accomplish the functions of the noise level indicator. Likewise, while the preferred form of the housing of the noise level indicator is that of a traffic light, other attention-getting housings can be used such as other road or construction signs, statues, and sculptures. Likewise, the lights can be used exclusive of sounds and vice-versa such as a statue incorporating the sounds but not the lights. Also, the microphone and power supply can be integral or separate plug-in devices to the housing. Thus, the scope of the invention should be determined by the appended claims and their legal equivalents rather than by the examples given.

What is claimed is:

1. A noise level indicator which provides indication to persons present in the adjacent area of the ambient noise level, comprising:
a microphone adapted to pick up and convert sound waves to an electrical signal;
an audio amplifier which is operatively connected to said microphone for receiving and amplifying the electrical signal;
a logic network which is operatively connected to said audio amplifier for receiving an output from the audio amplifier, said logic network being adapted to produce electrical output signals indicative of the ambient noise level input to said microphone; and
an indicator operatively connected to said logic network adapted to convert said electrical output signals from said logic network to indications of the ambient noise level, said indications being when the ambient noise level is generally below a predetermined decibel level, is generally at the predetermined decibel level, and is generally above the predetermined decibel level, said indications being perceptible by the persons in the adjacent area.

2. The noise level indicator of claim 1, further comprising:
an elongate, generally rectangular housing configured to generally resemble a traffic signal, having a front side with three large holes disposed in a vertical line one above the other, said housing which encloses the audio amplifier, the logic network, and the indicator; and
wherein said indicator comprises three lights of different colors which are visible through respective of said three large holes, an uppermost light appearing red when illuminated, a middle light appearing yellow when illuminated, and a lowermost light appearing green when illuminated, and wherein said logic network is adapted to cause said lowermost light to illuminate when the ambient noise level is generally below the predetermined decibel level, cause said middle light to illuminate when the ambient noise level is generally at the predetermined decibel level, and cause said uppermost light to illuminate when the ambient noise level is generally above the predetermined decibel level.

3. The noise level indicator of claim 2, further comprising a variable sensitivity selector which is operatively connected the audio amplifier and the logic network, said variable sensitivity selector which allows manual control of the output from said audio amplifier to said logic network so as to effectively control the predetermined decibel level at which the respective lights illuminate.

4. The noise level indicator of claim 3, wherein the middle light illuminates by flashing.

5. The noise level indicator of claim 3, further comprising a speaker and a speaker controller, said speaker controller being operatively connected to the logic network to generate a distinguishing sound through said speaker for one or more of the lights when illuminated to attract the attention of the persons in the adjacent area.

6. The noise level indicator of claim 5, wherein the distinguishing sound is generated starting when the middle light begins initial illumination.

7. The noise level indicator of claim 6, wherein the distinguishing sound is generated only for a predetermined time period following initial illumination.

8. The noise level indicator of claim 6, wherein the middle light illuminates by flashing.

9. The noise level indicator of claim 5, wherein the distinguishing sound is generated starting when the uppermost light begins initial illumination.

10. The noise level indicator of claim 9, wherein the distinguishing sound is generated only for a predetermined time period following initial illumination.

11. The noise level indicator of claim 9, wherein the distinguishing sound comprises the sound of a siren.

12. The noise level indicator of claim 5, further comprising a sound shutoff switch which is operatively connected to the speaker to allow operation of the noise level indicator without any distinguishing sounds.

13. A noise level indicator which provides indication to persons present in the adjacent area of the ambient noise level, comprising:
a microphone adapted to pick up and convert sound waves to an electrical signal;
an audio amplifier which is operatively connected to said microphone for receiving and amplifying the electrical signal;
a logic network which is operatively connected to said audio amplifier for receiving an output from the audio amplifier, said logic network being adapted to produce electrical output signals indicative of the ambient noise level input to said microphone;
an indicator operatively connected to said logic network adapted to convert said electrical output signals from said logic network to indications of the ambient noise level, said indications being when the ambient noise level is generally below a predetermined decibel level, is generally at the predetermined decibel level, and is generally above the predetermined decibel level, said indications being perceptible by the persons in the adjacent area;
a variable sensitivity selector which is operatively connected said audio amplifier and said logic network, said variable sensitivity selector which allows manual control of the output from said audio amplifier to said logic network so as to effectively control the predetermined decibel level at which the respective lights illuminate; and
a speaker and a speaker controller, said speaker controller being operatively connected to said logic network to generate a distinguishing sound through said speaker for one or more of said lights when illuminated to attract the attention of the persons in the adjacent area.

14. The noise level indicator of claim 13, wherein the distinguishing sound is generated only for a predetermined time period following initial illumination of one of the lights.

15. The noise level indicator of claim 13, wherein the middle light illuminates by flashing.

16. The noise level indicator of claim 13, wherein the distinguishing sound is generated starting when the uppermost light begins initial illumination, the distinguishing sound comprising the sound of a siren.

17. The noise level indicator of claim 13, further comprising a sound shutoff switch which is operatively connected to the speaker to allow operation of the noise level indicator without any distinguishing sounds.

18. A method of controlling the ambient noise level of persons present in a specified area, comprising the steps of:
providing a noise level indicator in the form of a traffic light having respective red, yellow, and green illuminating lights responsive to the ambient noise level in the specified area; and
providing feedback concerning the ambient noise level to the persons present in the specified area using the noise level indicator by providing indications that the ambient noise level is acceptable by illuminating the green light, is marginal by illuminating the yellow light, and is excessive by illuminating the red light.

19. The method of claim 18, wherein the step of providing feedback includes the yellow light illuminating by flashing.

20. The method of claim 18, wherein the step of providing feedback includes generating a distinguishing sound which starts when at least a designated one of the lights begins initial illumination.

21. The method of claim 18, wherein the step of providing feedback includes generating a distinguishing sound in the form of a siren which starts when the red light begins initial illumination.

22. The method of claim 21, wherein the step of providing feedback includes the yellow light illuminating by flashing.

23. The method of claim 22, wherein the step of providing feedback includes generating a distinguishing sound when a light begins initial illumination.

24. The method of claim 23, wherein the step of providing feedback includes generating the distinguishing sound only for a predetermined time period following initial illumination of the respective light.
